(19) United States
(12) Patent Application Publication
(10) Pub. No.: US 2006/0046226 A1
(43) Pub. Date: Mar. 2, 2006

(54) Dental imaging system and method of use

(76) Inventors: Hans Jorg Bergler, Bingen (DE); Keith Allan Sather, Lake Forest, CA (US)

Correspondence Address: STETINA BRUNDA GARRED & BRUCKER, 75 ENTERPRISE, SUITE 250, ALISO VIEJO, CA, 92656, US

(21) Appl. No.: 11/210,913

(22) Filed: Aug. 24, 2005

Related U.S. Application Data
(60) Provisional application No. 60/605,011, filed on Aug. 27, 2004.

(51) Int. Cl. A61C 1/00; A61C 3/00

(52) U.S. Cl. 433/29; 433/77

(57) ABSTRACT

Provided is a dental imaging system comprising a support frame, an imaging device and a display device. The support frame may include an upright portion mounted upon a base portion which may be portably or stationarily mounted. The imaging device is integrally mounted to the support frame as is the display device. The display device is conductively connected to the imaging device and is preferably configured to display images produced by the imaging device. The dental imaging system is adapted for endoscopic viewing of subgingival anatomy in a unitary structure to minimize space limitations of dental facilities.

### CROSS-REFERENCE TO RELATED APPLICATIONS

This application claims priority to pending U.S. Provisional Patent Application No. 60/605,011 entitled DENTAL IMAGING SYSTEM AND METHOD OF USE filed on Aug. 27, 2004, the entire contents of which is incorporated by reference herein.

### STATEMENT RE: FEDERALLY SPONSORED RESEARCH/DEVELOPMENT

(Not Applicable)

### BACKGROUND OF THE INVENTION

The present invention relates generally to dental equipment and, more particularly, to an integrated dental imaging system that combines a support frame with an instrument console for supporting various dental handpieces such as a perioscope, a display device as well as other diagnostic and treatment devices. The perioscopic device is specifically adapted for permitting visualization, guidance, monitoring and/or assessment of different types of treatment procedure directed to subgingival tooth surfaces or perodontium.

Furthermore, the invention applies fiber optic-based endoscopy technology to subgingival visualization and therapy of periodontal diseases and removal of calculus, plaque and other structures below the gum line. Advantageously, the present invention integrates endoscopy technology into the support frame and/or dental chair to facilitate combination and co-use of various dental treatment devices that are currently provided as individual standalone pieces of dental equipment.

In the field of dentistry, periodontal disease encompasses a group of disorders affecting the gums of the teeth. It is often desirable to exam the subgingival tissue which surrounds the teeth in order to detect the presence of various diseases including periodontal diseases. Such periodontal diseases may include root fractures, restoration margins and tooth decay. Plaque that is associated with periodontal disease typically begins with the formation of supragingival plaque which, if left untreated, invades the normally closed space between the free gingiva and the tooth surface.

If left unremoved, such supragingival plaque gives rise to the formation of hardened calculi and areas of erosion on the subgingival surfaces of the tooth. Inflammation of the surrounding tissues and recession of the connective tissue and bone may then occur. The loss of ligamentous attachment and surrounding bone mass in periodontal disease often results in the loss of the effected tooth unless effective treatment is timely administered. As may be appreciated, the inability to adequately visualize and examine the subgingival tooth surfaces makes it virtually impossible to provide effective therapy and treatment of certain periodontal diseases.

In the prior art, several non-invasive examination methodologies have been developed in order to provide direct subgingival visualization to detect the presence of various diseases including periodontal diseases. Such non-invasive examination methodologies include tactile exploration and radiographs of the supporting structures of the teeth. In addition, various imaging apparatus have been developed to facilitate subgingival visualization and therapy of periodontal diseases as well as facilitate removal of calculus, plaque and other structures below the gum line.

For example, prior art subgingival imaging systems such as borescopes and endoscopes are presently used to inspect the subgingival region. Unfortunately, such prior art subgingival imaging systems comprise standalone portable units that are configured to be positionable within a treatment area such as in a dental office. Furthermore, such prior art subgingival imaging systems may be quite large and may consume substantial space within the dental office in order to allow an adequate environmental condition for treatment of the patient.

Even further, such prior art subgingival imaging systems typically incorporate at least one or more dedicated irrigation systems that are configured to facilitate visual assessment of subgingival tissues and tooth surfaces. More specifically, the irrigation systems facilitate subgingival viewing by periodically discharging irrigation fluid. Such discharge of irrigation fluid may be utilized to accomplish periodic and/or continuous washing of the periodontal pocket during operative use of the instrument in order to clear blood and/or debris from the visualized field.

Such washing within the periodontal pocket facilitates visualization of the subgingival tooth surfaces as desired as well as causing distension of the periodontal pocket by insufflation with the infused irrigation fluid. Even further, such prior art subgingival imaging systems may also include one or more suction sources to further aid in visualizing the subgingival area of interest. More specifically, such suction source may provide aspiration of fluid and/or debris out of the periodontal pocket.

Unfortunately, such auxiliary devices such as the irrigation system and the suction or aspiration system mentioned above as well as the subgingival imaging system each require certain utilities for their operation. For example, a source of compressed air, vacuum source and irrigation fluid source may be required for operation of the above mentioned devices. More specifically, a dental office may require the installation of utilities such as a compressor, vacuum pump and associated plumbing connections. Furthermore, conduits, controls and other components may be required for operation of the above mentioned utilities. As was earlier mentioned, such treatment applications typically require that the above mentioned systems are provided as standalone pieces of equipment in the dental facility. Unfortunately, multiple pieces of such equipment occupy the limited confines of the dental facility in order to allow for adequate treatment of patients.

Dental imaging systems of the prior art suffer from other significant drawbacks that detract from their overall utility. For example, prior art imaging systems typically include several displays upon which images of the subgingival area are displayed. The use of such multiple displays requires that the dentist performing the treatment scans from screen to screen to patient while simultaneously manipulating the imaging device within the patient's mouth. Such scanning is required in order to ensure a wide viewing angle of coverage during the subgingival visualization operation.

As can be seen there exists a need in the art for a dental imaging system that facilitates the combination and co-use of various dental treatment devices that collectively exist as multiple pieces of standalone equipment in dental facilities. Furthermore, there exists a need in the art for a dental imaging system that includes a perioscopy treatment device having better viewing angles for more effective treatment. Additionally, there exists a need in the art for a dental imaging system that is comprised of integrated units of dental equipment that occupy less dental facility space as compared to prior art dental imaging systems. Also, there exists a dental imaging system wherein a chair portion is integrated with the various auxiliary medical and dental devices to improve the number of treatment options available with a single unitary piece of equipment.

Also, there exists a need in the art for a dental imaging system wherein the combination of multiple units of dental equipment into a single integrated imaging system allows for reduced treatment time and a decrease in post-operative discomfort and sensitivity by patients. Finally, there exists a need in the art for a dental imaging system having improved ergonomic configurations without requiring direct visualization of the treatment area by the dentist. Furthermore, there exists a need in the art for a dental imaging system providing direct access to periodontal pockets for improved efficiency in root debridement. Finally, there exists a need in the art for a dental imaging system which allows for reduced anesthesia during treatment procedures to thereby improve patient comfort and recovery time.

### BRIEF SUMMARY OF THE INVENTION

The present invention specifically addresses and alleviates the above-referenced deficiencies associated with dental imaging systems. More particularly, the present invention is an improved dental imaging system that integrates a support frame with an imaging device. The imaging device is preferably configured as a perioscopic device. The dental imaging system includes a support frame which may include a base portion and an upright portion extending vertically from the base portion. The base portion may include wheels so as to be portable. Alternativley, the base portion may be configured to be staticly or stationarily mounted such as on a floor. For the portable version, the base portion may include laterally outwardly extending arms having wheels disposed on extreme ends thereof to facilitate movement of the dental imaging system.

The upright portion of the support frame may include various devices for attachment of utilities to the dental imaging system. For example, the support frame may include power cord utilities or irrigation utilities to provide power and irrigation services during dental treatments. The upright portion may also include a protection shield disposed generally along the upright portion and vertically oriented. At an upper end of the upright may be an arm assembly that is removably coupled to the display device in order to allow reorientation of the display device during treatment procedures.

The display device may be configured in a variety of different apparatus including a liquid crystal display (LCD) monitor that may preferably be utilized with the dental imaging system. The LCD monitor may be a flat panel video monitor or any other suitable display device. Preferably, the display device will enable direct visualization of tooth root tissue in order to enhance treatment operations such as cleaning, scaling and root planing.

On opposite sides of the display device may be a pair of handholds which also may serve as mounts for various instruments. The handholds are preferably configured to be removable such that they may be sterilized. Furthermore, the handholds are preferably ergonomically shaped to enhance operability. As was earlier mentioned the handholds may be configured as instrument and/or endoscope rests or mounts. The endoscope device is preferably a fiber optic micro or miniature endoscope that may be mounted on one of the handholds. The dental imaging system may include a controller which is provided to allow for hands-free operation and control of the dental imaging system.

The controller may be either floor mounted or mounted on the support frame. The controller may be provided with a series of pedals and/or buttons or switches to allow for control of various functions of the dental imaging system. For example, the controller may be utilized to operate the display device and/or the imaging device. The irrigation fluoride may be provided to the area being treated and may be controlled in incremental steps by configuring the pedal or the controller to allow for an increase or decrease in the level of flow rate by light foot-tapping on the foot pedal control system. Various other parameters of the dental imaging system may be controlled by manipulating the switches, pedals and buttons on the controller. For example, video image brightness of the display device may be controlled by manipulating the controller.

The display device may include a control module which is preferably integrated therewith. The control module may preferably be configured to include at least one and preferably several ports to allow for video recording input, water irrigation connections as well as fiber optic endoscope interconnects. Irrigation and control of the imaging device and display device and other auxiliary deices may be easily controlled by the control module. The control module may further include image processing software and may also include a complimentary metal-oxide-semiconductor (CMOS) camera to provide a high degree of resolution in viewing images that are produced by the imaging device. LED read-outs may also be integrated into the control module and/or display device to provide an indication of illumination and irrigation systems of the dental imaging system.

As was earlier mentioned, the imaging device is preferably configured as a fiber optic micro or miniature endoscope. More preferably, the endoscope may be configured as a 0.99 diameter fiber optic endoscope that incorporates and integrates an illumination device therewith. Such illumination device preferably allows for imaging of the subgingival roots surfaces and other areas of interest. A lens assembly may be included with the imaging device to magnify the imaged area to a preferable magnification level of 24 times to about 48 times. If configured as a perioscope, the perioscope may comprise a body having a proximal portion and a distal portion with a proximal portion being detachable coupled to the imaging device.

At least one imaging element and, preferably, one or more illumination elements may be disposed adjacent the distal portion. The illumination elements are preferably configured to illuminate the area of interest while the imaging device captures the images formed of reflective light produced by the illumination elements. It should be noted that other medical instruments and/or dental instruments may be incorporated with the imaging device. For example, diagnostic exploration may be utilized by incorporating a shield member to aid in the examination and visualization of subgingival tissue. Ultrasonic adapters may be integrated with the imaging device in order to provide necessary treatments during certain dental procedures. A bioillumine sheath may be incorporated to enclose and protect flexible fiber portions of the endoscope. The dental imaging system may include a light source which is configured to supply light to the illumination device.

The control module may be included with the dental imaging system and is preferably configured to process images produced by the imaging device. In this regard, at least one memory device may be incorporated into the control module to store images produced by the imaging device. The control module is also preferably configured to format the images for display on the display device. Appropriate software may also be included for internal detection, processing, compression and conversion of such images.

### BRIEF DESCRIPTION OF THE DRAWINGS

These as well as other features of the present invention will become more apparent upon reference to the drawings wherein:

FIG. 1 is a prospective view of a dental imaging system of the present invention comprising a support frame having an imaging device and a display device integrally mounted thereto with the display device being conductively connected to the imaging device;

FIG. 2 is a prospective view of a dental imaging system in an alternative embodiment further comprising a chair portion integrally mounted to the support frame and further including an operating lamp moveably coupled to the support frame;

FIG. 3 is a top view of the dental imaging system shown in FIG. 2 and further illustrating an articulated arm moveably coupling an instrument console to the support frame and further illustrating the instrument console having the imaging device mounted thereupon;

FIG. 4 is an end view of the dental imaging system shown in FIG. 2 and further illustrating a spittoon and a faucet mounted upon the support frame;

FIG. 5 is a partial view of the imaging device configured as a perioscope having a body with a proximal portion and a distal portion and further illustrating a plurality of illumination elements surrounding an imaging element at the proximal portion of the perioscope; and

FIG. 6 is a perspective view of a pair of control modules interconnecting the imaging device to the display device.

### DETAILED DESCRIPTION OF THE INVENTION

The following detailed description and accompanying drawings are provided for purposes of illustrating and describing presently preferred embodiments of the invention and are not intended to limit the scope of the invention in any way.

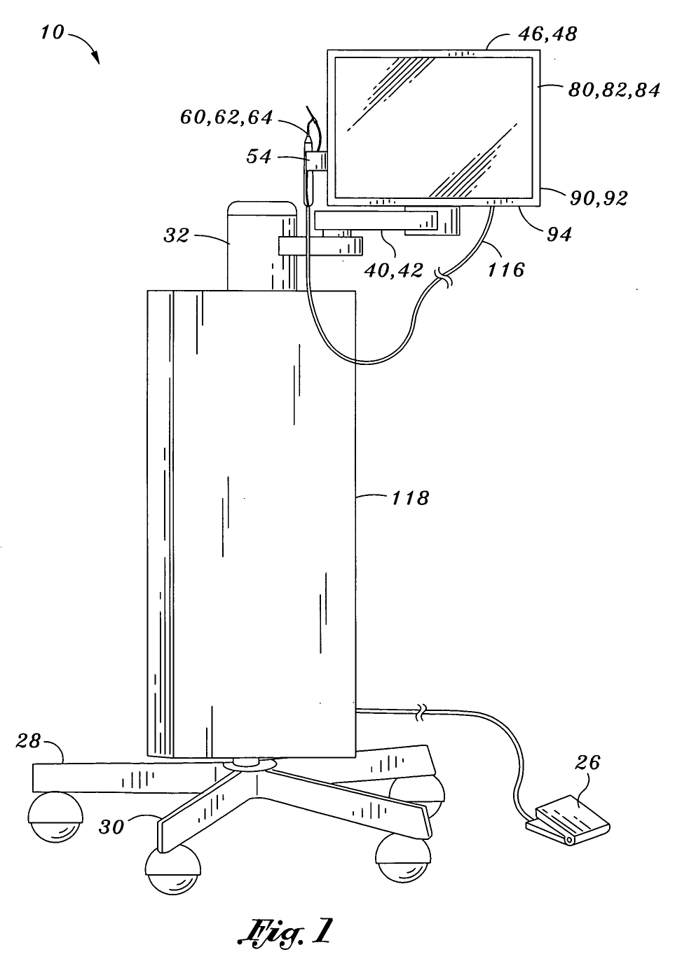

Shown in FIG. 1 is a dental imaging system 10 which, in its broadest sense, comprises a support frame 28 having an imaging device 60 integrally mounted thereto. As will be described in greater detail below, the imaging device 60 is preferably configured as a perioscopic device which is preferably configured as a fiber-optic based endoscope 62 similar to that shown and described in U.S. Pat. No. 5,230,621 entitled Endoscopic Method and Device for Subgingival Dental Procedures issued to Jacoby, U.S. Pat. No. 5,328,365 entitled System and Method for Endoscopic Subgingival Dental Procedures issued to Jacoby, U.S. Pat. No. 5,347,990 entitled Endoscope with Sterile Sleeve issued to Ebling, U.S. Pat. No. 5,569,161 entitled Endoscopic Sterile Sleeve issued to Ebling, the entire contents of each of the above referenced patents being incorporated by reference herein. In addition, the imaging device 60 may be configured as the device shown and described in U.S. Pat. No. 6,007,333 entitled Endoscopic Method and Device for Subgingival Dental Procedures issued to Callan, the entire contents of which is hereby incorporated by reference.

As can be seen in FIG. 1, the support frame 28 may be configured to have a base portion 30 which may be configured as a five-caster star pod base having laterally outwardly extending arms with wheels disposed on extreme ends thereof. As will be recognized, the base portion 30 may be configured in any arrangement other than the five caster star pod configuration. Preferably, the base portion 30 is configured to allow either portable or stationary placement within the dental facility. As such, it should be understood that the representation of the support frame 28 in FIG. 1 is exemplary only and is not to be construed as limiting the specific configurations thereof.

Also shown in FIG. 1 is the support frame 28 having an upright elongate portion extending upwardly from the base portion 30. Mounted to the upright portion 32 may be various devices for attachment of utilities to the dental imaging system 10. For example, the support frame 28 may have a retractable power cord mechanism mounted on the upright portion 32. In addition, the upright portion 32 may have a retractable irrigation channel mechanism mounted thereon to provide irrigation during dental treatments. Also mounted on the upright portion 32 may be a protection shield 100 which may be disposed as a generally elongate and vertically oriented member. At an upper end of the upright portion 32 may be an arm assembly 40 to moveably couple the display device 46 to the support frame 28.

The arm assembly 40 is preferably configured as an articulated arm 42 that is preferably configured to enable a flexible positioning of the display device 46 or of the other medical or dental instrument or device mounted thereon. In this manner, the arm assembly 40 allows for the user to control the orientation of the display device 46 to suit individual treatment procedures being performed. It is contemplated that the arm assembly 40 and, more particularly, the articulated arm 42 is configured as a spring balanced arm that allows for vertical and/or horizontal or lateral adjustment of the display device 46 or other device mounted thereon. A swivel feature may also be provided on an end of the arm to which the display device 46 or other device is mounted to permit easy movement and orientation of the display device 46 for effective viewing by the user and/or patient.

Regarding the display device 46 itself, it is contemplated that a liquid crystal display (LCD) monitor 48 may be utilized preferably with the dental imaging system 10. The LCD monitor 48 may be a flat panel video monitor 48 that is configured to capture and display images produced by the imaging device 60. The imaging system comprising the imaging device 60 in combination with the display device 46 enables direct vision of tooth root tissue in order to enhance traditional treatment operations such as cleaning, scaling and root cleaning.

Regarding the support frame 28, it is contemplated that casters and/or wheels are provided thereupon in order to allow portability and mobility thereof such that the dental imaging system 10 may be moved between dental facility rooms or operatories. It is also contemplated that the support frame 28 is configured to be height positionable such as via a telescoping tubing arrangement. Stability of the support frame 28 may be enhanced by configuring the support frame 28 such that the base portion 30 is bottom-weighted for stability. Regarding the arm assembly 40, it is contemplated that more than one arm assembly 40 may be included with the support frame 28 such that additional devices may be attached thereto.

Referring back to the display device 46 of FIG. 1, it is contemplated that a video display is mounted in a master control unit that is preferably a compact solid state configuration. As was earlier mentioned, it is contemplated that the display device 46 is configured as a color LCD video display monitor 48 that may be a flat screen monitor 48. On at least one side and, preferably on both sides, the display device 46 may include handholds 54 to facilitate positioning of the display device 46 according to the requirements of the user. It is also contemplated that the handholds 54 are configured to be removable and/or sterilizable and may also be ergonomically designed to enhance operability.

The handholds 54 may preferably be configured as instrument and/or endoscope 62 rests or mounts. As can be seen in FIG. 1, the endoscope 62 described above is a fiber-optic micro or miniature endoscope 62 that may be mounted on one of the handholds 54. A separate device may be mounted on the other one of the handholds 54. Near the base portion 30 and preferably configured to be floor-mounted, a controller 26 may be provided in order to allow for hands-free operation and control of the dental imaging system 10. The controller 26 may be provided with a series of pedals and/or buttons or switches that allow for control of various systems on the dental imaging system 10 including, but not limited to, the imaging device 60 and the display device 46. However, it is contemplated that various features of the dental imaging system 10 may be included.

For example, irrigation fluoride may be controlled in incremental steps by configuring the pedal of the controller 26 to increase or decrease the level of flow rate by a light foot tapping on the foot pedal control system. Various parameters of the imaging device 60 (i.e., the video monitor 48) may be controlled by manipulating the buttons disposed on the controller 26. For example, video image brightness may be controlled by pressing any one of the buttons on the controller 26. Although the controller 26 is configured to be mounted on a floor, it is further contemplated that the controller 26 may be a hand operated control unit that may be mounted adjacent to or upon the support frame 28. However, it is believed that a floor mount system for the controller 26 is advantageous to ensure that sterilization remains unbroken during perioscopy procedures and treatments.

The display device 46 may be configured to include a control module 94 integrated with the display device 46. The control module 94 may also be mounted as a separate component that is disposed adjacent to the support frame 28. As shown in FIG. 1, the control module 94 may be integrated with the display device 46 wherein the spray monitor 48 is disposed on one side and the control module 94 is disposed on an opposite side. The control module 94 is preferably configured to include at least one and preferably several ports to allow for video recording, water irrigation as well as fiber-optic endoscope 62 interconnects. As was earlier mentioned, irrigation and control of the imaging device 60 and display device 46 may be easily controlled by the control module 94 which may be mounted on the floor adjacent to the imaging system.

However, the irrigation and operation of the imaging and display devices 46 may be also controlled using the control module 94 disposed adjacent to the display device 46. The control module 94 may further include image processing software and may also include a complementary metal-oxide-semiconductor (CMOS) camera. Such CMOS camera provides a high degree of resolution in viewing images produced by the imaging device 60. The control module 94 may further include internal detection, processing, compression and conversion capabilities for formatting and processing the images produced by the imaging device 60. LED readouts may be also integrated into the control module 94 and/or display device 46 in order to provide an indication of illumination and irrigation systems of the dental imaging system 10. It is contemplated that the above described features may be integrated into a single unitary structure which includes the display device 46.

Importantly, the imaging device 60 is additionally integrally mounted to the support frame 28 and/or the display device 46. As was earlier mentioned, the imaging device 60 is preferably configured as a fiber-optic micro or miniature endoscope 62. However, the imaging device 60 may be also configured in the form of a perioscope 64 and a borescope 76. However, for purposes of this disclosure, it would be appreciated that a perioscope 64 is generally a subset of an endoscopic device wherein the perioscope 64 is an endoscope 62 that is utilized for scaling and root cleaning and may be aided by indirect vision via an endoscope 62. If the imaging device 60 is configured as a borescope 76, the borescope 76 is preferably a flexible borescope 76 as opposed to a rigid borescope 76. A magnifying device may be included with the flexible borescope 76 and may also include an illumination device 88 configured to illuminate the area being visually inspected and/or examined. In this regard, illumination fibers contained within a borescopic tubular member may be used to direct light through the illumination fibers onto the area.

As was earlier mentioned, the endoscope 62 may be configured similar to that disclosed and described in the above described U.S. Patents. In this regard, the endoscope 62 may be configured as a 0.99 diameter fiber-optic endoscope 62 which incorporates and integrates an illumination device 88 therewith. The illumination device 88 is preferably integrated with the imaging device 60 and is disposed adjacent thereto and is preferably configured to illuminate an area being imaged by the imaging device 60. Such illumination device 88 allows for imaging of the subgingival root surfaces. The imaging device 60 may include a lens assembly 86 which is operatively coupled thereto and which is configured to magnify the imaged area. More specifically, the lens assembly 86 is preferably configured to magnify the area being imaged to a level of between about twenty-four (24) times to about forty-eight (48) times magnification. However, the lens assembly 86 may be configured to magnify the imaged area at any magnification level.

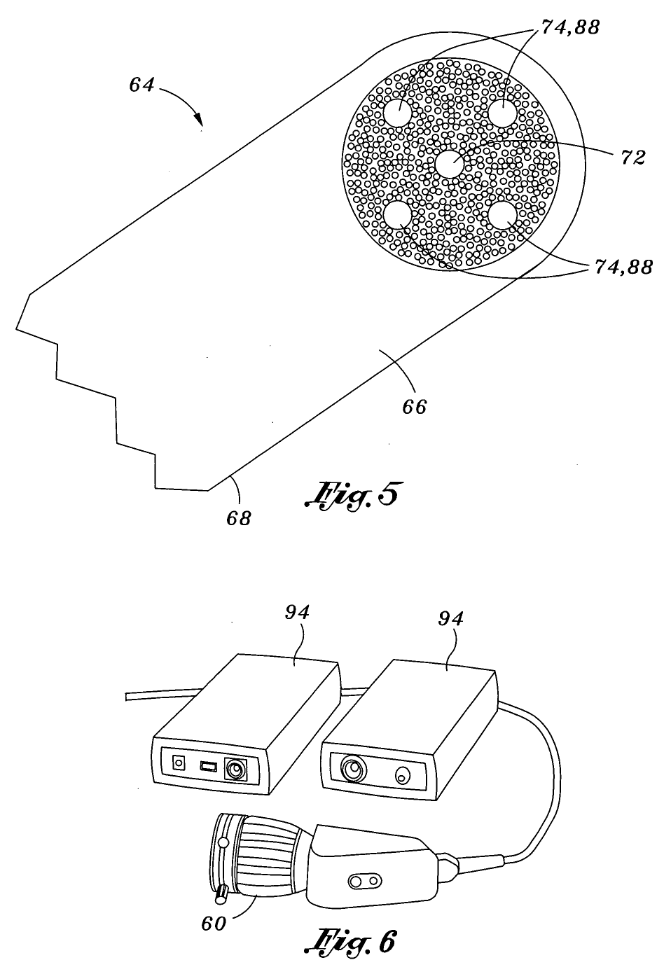

Referring to FIG. 5, shown is an embodiment of the perioscopy configuration of the imaging device 60. As can be seen, the perioscope 64 that may be used with the dental imaging system 10 comprises a body 66 having a proximal portion 68 and a distal portion 70. The proximal portion 68 may be configured to be detachably coupled to the imaging device 60. The distal portion 70 preferably includes at least an imaging element 72 and may preferably also include one or more illumination elements 74. In the embodiment illustrated in FIG. 6, the periscope includes one (1) imaging element 72 and four (4) illumination elements 74 disposed around the centrally located imaging element 72.

As was earlier mention, the illumination elements 74 are each configured to illuminate an area of interest while the imaging element 72 is configured to capture an image formed of reflective light produced by the illumination elements 74. Although the periscope configuration shown in FIG. 5 illustrates that four (4) of the illumination elements 74, any number may be used. It should be additionally noted that other medical instruments 106 and dental instruments may be incorporated with the imaging device 60 configured as the perioscope 64. For example, diagnostic exploration tools may be utilized having tissue shield members to aid in the examination and visualization of subgingival tissue.

Furthermore, ultrasonic adapters may be integrated with the imaging device 60 in order to provide necessary treatments during certain dental procedures. The instrumentation may include pairs of left and right-hand explorers for subgingival viewing. As was earlier mentioned, the perioscope 64 may include a bioillumine sheath which encloses and protects flexible fiber portions of the endoscope 62. The flexible fiber portion may be comprised of up to ten thousand (10,000) image guides and nineteen (19) illumination fibers to produce the image. The dental imaging system 10 may further comprise a light source 90 which is configured to supply light to the illumination device 88.

Such light source 90 may be configured as a mental metal halide arc lamp 92 although other configurations of light sources 90 may be used to supply light to the illumination device 88. Referring back to FIG. 1, it is contemplated that the imaging device 60 may further comprise a camera 80, a charged-couple device 82 and/or a photodiode 84 configured for use with the imaging device 60. The charge-coupled device may be configured for recording images of areas of interest. The photodiode 84 may be provided with either a window or a fiber-optic connection to allow light to be directed upon the area of interest wherein the photodiode 84 response the optical light source 90. As was earlier mentioned, the camera 80 may be configured as a high resolution CMOS camera 80.

The dental imaging system 10 may be configured such that the imaging device 60 includes an x-ray device 78 in order to assist in the detection of cavities or caries that are infections caused by bacteria forming on or around teeth. In this regard, dental x-rays may be useful in finding such caries that may be wedged between teeth and are therefore difficult to detect using an endoscope 62. Likewise, the dental imaging system 10 may further comprise any number of auxiliary devices 98 that are integrated thereinto. Such auxiliary devices 98 may include but are not limited to, a suction device 104, an irrigation device 102, a light source 90 and a medical or dental instrument. Such imaging devices 60 are preferably operatively coupled to appropriate utilities for the above mentioned auxiliary devices 98. For example, the imaging device 60 is preferably coupled to at least a suction device 104, an irrigation fluid source, a medicament source 110, a pneumatic power source 112 and an electrical power source 112 for operating various medical and dental tools.

The control module 94 is preferably configured with a connector to connect the imaging device 60 to the display device 46. As was earlier mentioned, the control module 94 may include appropriate software for the processing of images produced by the imaging device 60. The control module 94 may also include at least one memory device 96 configured to store images produced by the imaging device 60. The control module 94 is therefore configured to store the images and format the images for display on the display device 46. In this regard, the control module 94 preferably includes appropriate software for internal detection, processing, compression and conversion of such images.

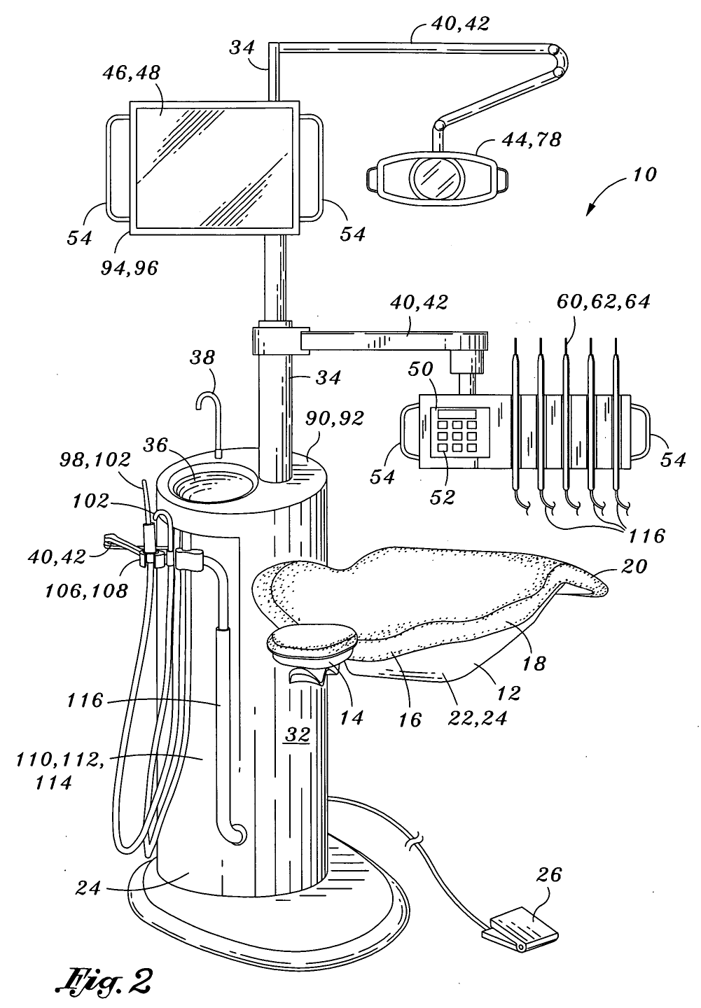

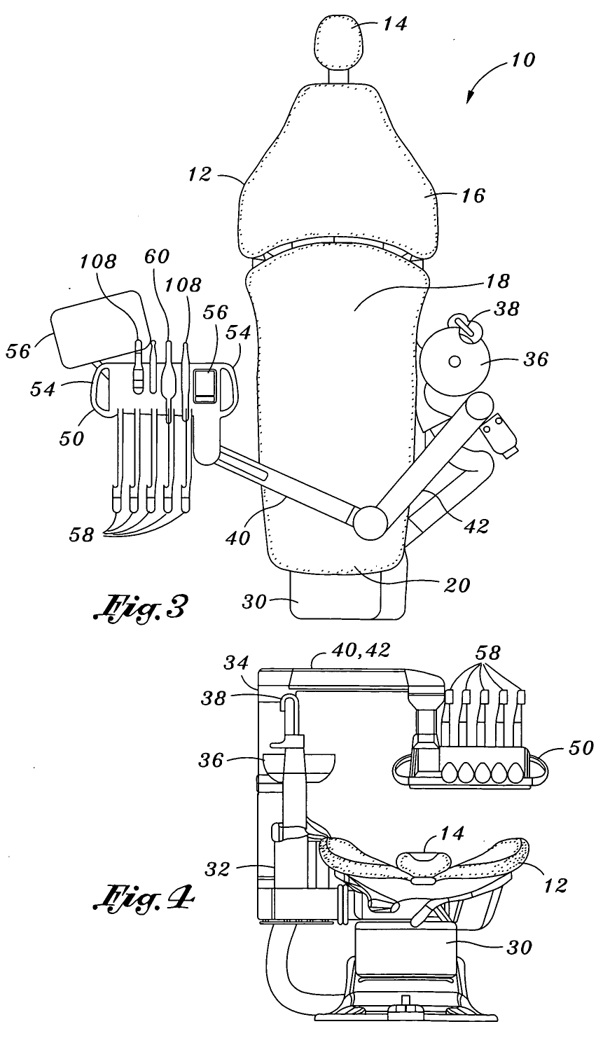

Referring now to FIGS. 2-4, shown is the dental imaging system 10 in an alternative embodiment further comprising a chair portion 12 that may be mounted to the support frame 28. In the configuration shown in FIGS. 2-4, the dental imaging system 10 is configured to be a stationary system wherein the base portion 30 is directly mounted to the floor as opposed to the movable arrangement shown in FIG. 1. The dental imaging system 10 shown in the embodiment of FIGS. 2-3 includes at least the features disclosed for that described above in FIG. 1. In addition, the dental imaging system 10 shown in FIGS. 2-3 has the chair portion 12 which is preferably configured to be selectively adjustable.

In this regard, the chair portion 12 is configured such that a patient may be supported in a variety of positions by reorienting the various portions of the chair. For example, the chair portion 12 as shown in FIG. 2 may comprise a headrest 14, a headrest 16, a seat 18 and a leg rest 20. Actuators 22 and/or motors 24 may be included with the chair portion 12 to allow for powered adjustment of the various portions of the chair portion 12. Such reorientation may be effectuated through the use of the controller 26 such as the foot mounted controlled shown in FIG. 2, or via the control module 94 which may be integrated with an instrument console 50. As shown in FIGS. 2-4, the instrument console 50 may be movably coupled to the support frame 28 via an articulated arm 42. The chair portion 12 may be either powered or may be manually adjustable such as by the dentist and/or patient. Furthermore, the chair portion 12 may be configured to be programmable to certain positions and settings depending on age and/or size of the patient. Optionally, the chair portion 12 may include arm rests and other support features.

The dental imaging system 10 shown in FIGS. 2-4 may also include an operating lamp 44 mounted to a post 34 extending upwardly from the support frame 28 and moveably coupled thereto via an articulated arm 42. The operating lamp 44 may be configured to be suspended over the chair portion 12 to facilitate the free positioning above and around the patient. Various conduits 116 may be connected from the support frame 28 to the auxiliary device 98. For example, pneumatic power may be provided to certain dental instruments through a conduit 116 configured to carry pressurize air.

Electrical power may be passed through a conduit 116 flexibly connected to a medical instrument 106. Dental handpieces 108 may further be provided as auxiliary devices 98. Each one of the dental handpieces 108 may be flexibly mounted on an instrument arm 58 that is configured to support a conduit 116 connecting the handpiece 108 to the instrument console 54. The instrument arm is prefeably configured to flex forward and aft during use of the dental handpiece 108. For example, turbine drill handpieces, micro-motor handpieces and spray handpieces may be incorporated into the dental imaging system 10.

Pressurized air may be required to be transmitted through the conduit 116 through to the turbine drill handpiece. In addition, auxiliary air and flushing fluid may be included to produce a spray mist during certain drilling and or grinding operations. Electrically driven handpieces such as the micro-motor handpieces may require electrical current for their operation. In this regard, the conduit 116 may be configured to carry electrical current to the handpiece. In addition, cooling air may be required for the electrical handpiece and such appropriate conduit 116 may thereby be provided.

Referring still to FIGS. 2-4, shown is the instrument console 50 which is movably coupled to the support frame 28. The instrument console 50 may include a work tray 56 which may be attached thereto and which the dentist may use in performing various treatments. At least one and preferably both sides of the instrument console 50 may be provided with a handhold 54 to allow for reorientation thereof by the dentist. A keypad 52 may be incorporated into the instrument console 50 and to provide a means of control or regulation of the imaging device 60, display device 46 and other auxiliary devices 98 of the dental imaging system 10.

Also included with the dental imaging system 10 in the embodiment shown in FIGS. 2-4 may be a spittoon 36 and a faucet 38. Such spittoon 36 and faucet 38 may be mounted on the support frame 28 and, more particularly, may be moveably mounted on the up right portion of the support frame 28. The control panel such as the keypad 52 mounted on the instrument console 50 may be utilized to position the spittoon 36 and faucet 38 complementary to the position of the chair portion 12.

The operation of the dental imaging system 10 will now be described with reference to the figures. As was earlier mentioned, the dental imaging system 10 of the present invention is specifically adapted for endoscopic examination of the subgingival anatomy. More specifically, the dental imaging system 10 of the present invention is directed towards visualization of the area between the free gingiva and the subgingival tooth surface. Advantageously, such dental imaging system 10 allows for the capture and display of real time images produced by the endoscope 62. Irrigation and illumination may be simultaneously provided during such visualization and may be controlled using a controller 26 as was earlier described.

The method for endoscopic examination of the subgingival anatomy comprises the steps of inserting the endoscope 62 between the free gingiva and the subgingival tooth surface. Simultaneously, light may be passed from the light source 90 to the illumination device 88 such that the light is directed upon the area being visualized (i.e., the area between the free gingiva and the tooth surface). Thereafter, the endoscope 62 produces an image based upon light reflected off of the area of interest. The image produced by the endoscope 62 is then transmitted to the control module 94 for formatting. In this regard, such formatting may include the steps of initially detecting the image by the endoscope 62, storing the image, compressing the image, and converting the image. Following processing of the image by the control module 94, the image is then transmitted to the display device 46 for display thereupon and observation by the dentist, dental assistant and/or patient.

Control of the display device 46 may be effectuated through the use of the controller 26 which may be the floor-mounted version of the controller 26 and/or the keypad 52 version of the controller 26 which may be mounted on an instrument console 50. Such endoscopic examination may allow for identification of root fractures, subgingival caries (i.e., cavities), etc. The method described above allows for visualization of the results of scaling and root cleaning treatments as well as allowing for the performance of other subgingival diagnostic and therapeutic procedures. Advantageously, real time visualization of the subgingival portions is enhanced by the magnification of the endoscope 62. In this manner, small deposits of residual calculus as well as inflammations of soft tissue and open crowns may be easily viewed.

The above description is given by way of example, and not limitation. Given the above disclosure, one skilled in the art could devise variations that are within the scope of the invention disclosed herein. Furthermore, the features of the embodiments disclosed herein can be used alone or in varying combinations with each other and are not intended to be limited to the specific combinations or methodologies described herein. Thus, the scope of the claims is not to be limited by the illustrated embodiments.

What is claimed:

1. A dental imaging system, comprising:
a support frame;
an imaging device integrally mounted to the support frame; and
a display device integrally mounted to the support frame and conductively connected to the imaging device, the display device being configured to display images produced by the imaging device.

2. The dental imaging system of claim 1 further comprising a chair portion mounted to the support frame.

3. The dental imaging system of claim 1 wherein the support frame includes at least one arm assembly movably coupling the display device to the support frame.

4. The dental imaging system of claim 1 further comprising at least one of a spittoon, a faucet and a work tray mounted on the support frame.

5. The dental imaging system of claim 1 further comprising a controller operatively connected to the imaging device and being configured to allow for selective control thereof.

6. The dental imaging system of claim 1 wherein the imaging device is configured in the form of at least one of an endoscope, a perioscope and a borescope.

7. The dental imaging system of claim 1 wherein the imaging device is a fiber-optic based endoscope.

8. The dental imaging system of claim 1 wherein the imaging device is an x-ray device.

9. The dental imaging system of claim 1 further comprising at least one of a camera, charge-coupled device and photodiode configured for use with the imaging device.

10. The dental imaging system of claim 1 wherein the imaging device includes a lens assembly operatively coupled thereto and being configured to magnify the imaged area.

11. The dental imaging system of claim 1 further comprising an illumination device disposed adjacent to the imaging device and being configured to illuminate an area imaged thereby.

12. The dental imaging system of claim 11 further comprising a light source configured to supply light to the illumination device, the light source being configured as a metal halide arc lamp.

13. The dental imaging system of claim 1 wherein the display device is configured as an LCD monitor.

14. The dental imaging system of claim 1 further comprising an operating lamp movably coupled to the support frame.

15. The dental imaging system of claim 1 wherein the orientation of the chair portion is selectively adjustable such that a patient may be supported in a variety of positions.

16. The dental imaging system of claim 1 further comprising an auxiliary device integrated into the imaging device and being selected from the group consisting of a suction device, an irrigation device, a light source, a medical instrument.

17. A dental imaging system adapted for endoscopic viewing of subgingival anatomy, comprising:
a support frame having at least one arm assembly;
a display device movably coupled to the arm assembly;
a fiber-optic based endoscope configured to be insertable between free gingiva and an adjacent tooth, the endoscope being conductively connected to the display device such that the display device displays images produced by the endoscope;
an illumination device integrated into the endoscope and being configured to illuminate an area imaged thereby;
a light source configured to supply light to the illumination device, the light source being configured as a metal halide arc lamp; and
a control module having at least one memory device and being configured to store the images and format the images for display on the display device.

18. The dental imaging system of claim 17 further comprising at least one auxiliary device selected from the group consisting of a suction device, an irrigation device, a dental instrument, a medical instrument.

19. A method for endoscopic examination of the subgingival anatomy using the dental imaging system of claim 17, the method comprising the steps of:
inserting the endoscope between the free gingiva and the subgingival tooth surface;
passing light from the light source to the illumination device such that light is directed upon the area between the free gingiva and the tooth surface;
producing an image of the area between the free gingiva and the tooth surface;
transmitting the image to the control module for formatting; and
transmitting the image to the display device for display thereon.

20. The method of claim 17 wherein the step of processing the image includes at least one of the steps of storing the image, compressing the image, and converting the image format.
